(19) United States
(12) Patent Application Publication
(10) Pub. No.: US 2018/0079030 A1
(43) Pub. Date: Mar. 22, 2018

(54) METHOD OF PRODUCING A MICROMACHINED WORKPIECE BY LASER ABLATION

(71) Applicant: Fraunhofer-Gesellschaft zur Förderung der angewandten Forschung e.V., Munchen (DE)

(72) Inventors: Michael Krause, Halle (DE); Thomas Höche, Halle (DE)

(21) Appl. No.: 15/707,097

(22) Filed: Sep. 18, 2017

(30) Foreign Application Priority Data
Sep. 19, 2016 (EP) 16189398.7

(51) Int. Cl. B23K 26/0622; B23K 26/00; B23K 26/382; B23K 26/40; C23C 28/00

(52) U.S. Cl. CPC B23K 26/0624; B23K 26/009; B23K 2201/35; B23K 26/40; C23C 28/3215; B23K 26/389

(57) ABSTRACT

A method of producing a micromachined workpiece by laser micromachining includes applying a protective layer (SS) to a surface (OF) of the workpiece (WS) and machining the surface in a machining area by a laser beam (LS) through the protective layer, wherein the protective layer (SS) is produced using a coating fluid (SF) containing an at least partially volatile carrier liquid (TF) in which metallic and/or ceramic particles (PT) are dispersed; the coating fluid (SF) is applied to the surface (OF) such that at least the machining area (MA) is covered with a protective coating fluid layer (SSF); the applied coating is dried to reduce the content of carrier liquid (TF) such that a protective layer (SS) forms, which is essentially composed of the particles (PT) of the applied coating fluid or of these particles and a reduced content of the carrier liquid relative to the coating fluid; and machining of the machining areas is carried out by a laser beam (LS) irradiated through the protective layer onto the workpiece (WS).

### TECHNICAL FIELD

This disclosure concerns a method of producing a micromachined workpiece by laser ablation, wherein a protective layer is applied to a machining area of the surface of the workpiece and the surface in a machining area is machined through the protective layer by a laser beam.

### BACKGROUND

Typical laser machining tasks in laser micromachining concern boring extremely fine holes, cutting notches, and ablation of flanks on workpieces. Because of the often Gaussian irradiation profile of laser beams, entry edges on workpiece surfaces often show elevations (burrs) or tend towards rounding in the vicinity of the surface and are lined with deposits adhering to the surface. Moreover, the entry edges are often exposed to strong temperature effects. Because of the ablation products (debris) that often cannot be fully removed and may firmly adhere to surfaces because of the highly-excited ablation plasma, the entry edges are often not ideally smooth due to the optical near-field interaction of the laser irradiation with locally adhering nanoscale ablation products, but may show curtaining.

GB 2349106 A discloses that deposition of ablation products (sputter) on the workpiece can be avoided during laser percussion drilling by applying a coating to the surface of the workpiece that contains particles dispersed in a polymer matrix. For example, the polymer matrix may be a silicone sealing material, and the particles may be composed of a ceramic material or a high melting material. The coating composition, in which the polymer matrix and the particles dispersed therein (in the example, silicon carbide) should be present in approximately the same proportions by weight, is hardened after distribution on the surface at room temperature or under heating. Among other requirements, the polymer coating, that adheres well to the surface, should limit the lateral spread of heat perpendicular to the laser beam so that the hole in the coating does not become substantially larger than the bore in the workpiece. After completion of the laser machining, the coating can be detached from the surface together with the ablation products.

JP H08187588 A describes the use of a protective film of polyimide on the surface of a workpiece processed by laser machining. The ablation products accumulate on the protective film and can be removed together therewith after laser machining.

DE 10 2006 023 940 A1 describes a method of nanostructuring a substrate by direct laser ablation. The surface to be irradiated is coated with a liquid, gel-like or cross-linked sacrificial layer that is transparent to the laser light used for pattern formation.

DE 101 40 533 B4 describes a method of micromachining a workpiece by ultra-short pulsed laser irradiation. In this method, a monolithic sacrificial layer composed, for example, of copper is firmly applied to a surface of the workpiece. Next, ultra-short laser pulses are generated that penetrate the sacrificial layer and remove the material of the workpiece. After sufficient ablation of the material of the workpiece, the sacrificial layer is removed. As the sacrificial layer is not solidly chemically bonded to the workpiece to be machined, the sacrificial layer is easy to remove after laser machining. The particles ablated from the workpiece that have been deposited on the free surface of the sacrificial layer are removed together with the sacrificial layer. The edge profile with rounded edges produced by the laser irradiation on the laser entry side is formed in the sacrificial layer and removed with the layer. This produces a sharp-edged contour in the transition area between the surface of the workpiece and the indentation or bore produced by laser irradiation.

It could therefore be helpful to provide a method of the type described above that makes it possible to improve the quality of the workpiece micromachined by laser ablation in the machined area over that of conventional methods.

### SUMMARY

We provide a method of producing a micromachined workpiece by laser micromachining, including applying a protective layer (SS) to a surface (OF) of the workpiece (WS) and machining the surface in a machining area by a laser beam (LS) through the protective layer, wherein the protective layer (SS) is produced using a coating fluid (SF) containing an at least partially volatile carrier liquid (TF) in which metallic and/or ceramic particles (PT) are dispersed; the coating fluid (SF) is applied to the surface (OF) such that at least the machining area (MA) is covered with a protective coating fluid layer (SSF); the applied coating is dried to reduce the content of carrier liquid (TF) such that a protective layer (SS) forms, which is essentially composed of the particles (PT) of the applied coating fluid or of these particles and a reduced content of the carrier liquid relative to the coating fluid; and machining of the machining areas is carried out by a laser beam (LS) irradiated through the protective layer onto the workpiece (WS).

### BRIEF DESCRIPTION OF THE DRAWINGS

FIG. 1 shows a section through a workpiece in the vicinity of a surface in which a hole is to be produced by laser micromachining, wherein a layer of the particle-containing coating fluid is applied to the surface in a locally limited manner.

FIG. 2 shows a schematic view of a drying step to produce a dried protective layer from the layer of the coating fluid.

FIG. 3 shows a machining step in which a laser beam is irradiated through the protective layer onto the workpiece.

FIG. 4 shows a wet chemical cleaning step to remove the protective layer after completion of the laser machining.

FIG. 5 shows a scanning electron microscope image of a workpiece covered with a layer of conductive silver after drying of the conductive silver layer and excavation by a focused Ga⁺ ion beam.

FIG. 6 shows four scanning electron microscope images of areas with an identical machining structure that are not protected by a protective layer after laser machining under different ambient pressure conditions.

FIG. 7 shows a SEM image of a semiconductor sample that was laser-machined and structured using a conductive silver protective layer after removal of the protective layer and the ablation products removed therewith.

FIG. 8 shows an SEM image of an FIB cross section perpendicular to a laser-machined flank.

FIG. 9 shows an example in which the protective layer was applied to the workpiece with an interposed particle-free intermediate layer.

FIG. 10 shows the removal of a protective layer from the workpiece surface by a CO₂ beam.

### DETAILED DESCRIPTION

In the method, the protective layer is produced using a coating fluid that contains a partially or completely volatile carrier liquid in which metallic and/or ceramic particles are dispersed. The coating fluid is applied to the surface of the workpiece such that at least the machining area intended for laser machining is covered with a layer of the coating fluid. The coating fluid may be directly or immediately applied to the surface or indirectly applied with an interposed intermediate layer.

The applied coating layer is then dried to reduce the content of carrier liquid such that a protective layer forms and is essentially composed of the particles of the applied coating fluid or of these particles and a reduced content or remaining amount of the carrier liquid relative to the coating fluid. The machining area is then machined by (at least) one laser beam irradiated through the protective layer onto the workpiece.

The coating fluid can be described as a flowable dispersion containing a liquid dispersion medium (the carrier liquid) and solid dispersed particles. The coating fluid is a flowable substance, the viscosity of which can be variously selected depending on the specific application. In this case, thin liquid coating fluids of the ink type having a viscosity similar to that of water or alcohol are just as suitable as viscous coating fluids, e.g. fluids having the viscosity of a lacquer, honey, a cream or a paste. In the method, the carrier liquid essentially serves as an auxiliary agent in positive-locking application or topography-adapted application of the coating fluid to the surface to allow a desired distribution of the particles on the surface.

The carrier liquid should be more or less readily volatile to facilitate the subsequent drying (complete or partial drying) of the applied layer. The carrier liquid can be selected such that volatile components can already evaporate at room temperature or slightly elevated temperatures so that, during the drying phase, the content of the carrier liquid in the coating is reduced or the particle content in the layer increases. To facilitate evaporation of the carrier liquid after application of the layer, the carrier liquid should, to the extent possible, be non- or low-polymerizing and non-curable or virtually non-curable. This facilitates possibly desired subsequent detachment of the layer after completion of laser machining.

The carrier liquid may be a single-component carrier liquid, i.e. a carrier liquid that essentially consists of one individual liquid component, optionally with impurities of other substances. It is also possible for the carrier liquid to consist of two or more components, i.e. to be a multi-component carrier liquid. For example, one of the components can be a relatively readily volatile component such as a component based on alcohol, a ketone such as acetone, or an acetate. Another component may be less readily volatile or non-volatile, and may optionally remain at least partially in the protective layer, where it promotes cohesion of the particles.

The layer may optionally dry automatically without any particular drying-promoting measures. It is also possible to actively accelerate the drying step, for example, by heating and/or blowing. In this manner, evaporation of the volatile components of the carrier liquid can be accelerated.

During the drying step, the applied layer, which may initially essentially retain the viscosity of the coating fluid, is dried to reduce the content of the (volatile) carrier liquid. By the drying step, a partially dried or virtually fully dried protective layer can be produced. A partially dried protective layer can still be wet and still contain portions of carrier fluid, at least in some areas, but its flowability is reduced to such an extent that it adheres well to the surface. In longer drying, the protective layer can dry out completely so that virtually no volatile components of the carrier liquid remain present in the protective layer.

Among other purposes, the drying step is intended to allow the workpiece, together with the partially dried or completely dried protective layer, to be tipped out of the horizontal plane if needed without causing the protective layer to detach from the surface. The protective layer should generally also be dry enough so that the site of laser ablation can be subjected to a targeted strong air flow during laser machining, without this causing the protective layer to lose its effectiveness.

For the material-removing laser ablation, the machining area is then machined by a laser beam irradiated through the partially dried or completely dried protective layer onto the workpiece. More preferably, this can be a pulsed laser beam produced, for example, with an ultrashort pulse laser.

By the method, both smooth and not completely smooth surfaces which, for example, may have slightly projecting conductor paths, can be coated in a conforming and positive-locking manner.

The composition or formulation of the coating fluid can be adjusted over a broad range to the conditions of the specific application. In many examples, a coating fluid is used in which the particles dispersed in the carrier liquid predominantly have a maximum particle size of 10 μm. In this context, “predominantly” means more particularly that at least 70% or at least 80% of the particles should have this relatively small size. More preferably, the average particle size may be in the single-digit micrometer range or below. Some or all of the particles may have an average particle size of less than 1 μm. The particles may be scale-like or flake-like (flakes), i.e. flat particles whose major diameter is much larger than their height. For example, the diameter can be a maximum of 10 μm, while the height can frequently be far less than 1 μm or in the range of a few hundred nanometers. As a rule, a certain distribution with respect to the form and/or shape of the particles is provided and is also useful to achieve a relatively dense microporous or nanoporous structure in the partially dried or completely dried protective layer.

The composition of the coating fluid can be selected such that the filling ratio of the particles in the finished (partially dried or completely dried) protective layer is significantly above 50% of the protective layer volume. The term “filling ratio” used here refers to the ratio of the total volume of the particles in a unit volume of the protective layer to the observed unit volume. For example, the filling ratio can be 60% or more or also at least 70%. In many silver inks, the silver particles are on a colloidal length scale, for example, in the size range of approx. 2 nm to approx. 20 nm. In such colloidal coating fluids, higher filling ratios, e.g. up to 90%, can be achieved. As a rule, the protective layer has residual porosity. Moreover, residues of the carrier liquid may also be present in the protective layer so that the filling ratio of the particles is usually less than 90%.

The materials of the particles can be adapted to the specific application. In many applications, it is advantageous if a coating fluid is used that is composed predominantly (e.g. to at least 80% or to at least 90%) or exclusively of metallic particles. In the use of metallic particles in the coating fluid, a protective layer with high thermal conductivity can optionally be produced, which generally has a beneficial effect on heat management or discharge of heat from the area directly affected by the laser beam. In addition, metals typically have a relatively high ablation threshold so that the protective layer equipped with metallic particles remains effective for long periods, even under long-term laser irradiation, for example, against edge rounding. Metallic particles may be uncoated or bear a layer such as a thin oxide or ceramic layer. Metallic particles (coated or uncoated) and ceramic particles may be mixed in with the carrier liquid or in the protective layer produced therefrom. As ceramics frequently have even higher ablation thresholds than metals, the resistance of the protective layer under laser irradiation can be further improved as needed by the use of ceramic particles (alternatively or in addition to metallic particles).

For example, many commercially available metal inks or metal lacquers with coated or uncoated particles of silver, gold, aluminium, copper, nickel and/or another metal and optionally (or additionally) containing ceramic particles are used as a coating fluid in the context of the method.

In many examples, a conductive lacquer is used as a coating fluid. The term “conductive lacquer” refers to an electrically conductive lacquer conventionally used primarily in electronics. The electrical conductivity is produced by a very high content (up to 80% or more) of conductive filler materials in the lacquer matrix. The individual particles are in contact with one another and thus allow the flow of current. For example, there are conductive lacquers based on silver (silver conductive lacquer or conductive silver), copper (copper conductive lacquer) and graphite particles (graphite conductive lacquer). The binder component can be a single-component solvent-containing lacquer or a synthetic resin (single- or dual-component).

We thus provide a new advantageous use for conductive lacquers containing metallic particles, more particularly conductive silver, that are conventionally used for other purposes, specifically as a coating fluid to produce a protective layer in the methods described in this application.

By the method, highly effective, multifunctional protective layers can be produced. In this case, relatively low effective layer thicknesses can be sufficient to reduce or prevent the above-mentioned problems. The term “effective protective layer thickness” refers in this context to the layer thickness of the protective layer during laser machining, i.e. when the layer is at least partially dry and adheres relatively securely to the surface.

Based on the assumption of a Gaussian irradiation profile, the effective layer thickness should be large enough so that as smooth a flank as possible is created in the workpiece without rounding. An important criterion is the intended action of sharpening the effective laser beam. In this case, moreover, the protective layer should be thin enough so that the laser beam penetrates to the workpiece surface within a limited time. In many examples, the protective layer is produced with an effective protective layer thickness of less than 50 μm. According to current findings, effective protective layer thicknesses of 5 μm to 50 μm appear in many practical cases to be advantageous. More particularly, it may happen in significantly smaller effective protective layer thicknesses that edge rounding extends into the area of the machined workpiece. Much greater layer thicknesses frequently appear to be unnecessary and would chiefly lead to greater material consumption of the coating fluid without corresponding added value.

However, it is entirely possible that much thicker layers are required, for example, for a 400 W laser with a highly unfavorable irradiation profile M²>2, i.e. a donut-shaped beam cross section. An optimum effective layer thickness may therefore also be more than 50 μm, for example, 50 μm to 200 μm or more, e.g. 1 mm or 2 mm.

In general, it is possible that the protective layer will remain on the surface after completion of the laser machining. For example, this can be the case in laser-based sample preparations for microstructural diagnosis. However, the protective layer should then be relatively thin to the extent possible, e.g. with an effective layer thickness of 5 μm to 10 μm. In many cases, however, the protective layer is removed from the surface after completion of the laser machining. In this manner, the deposits (debris) remaining on the protective layer can be removed from the workplace surface together with the protective layer.

A major advantage of preferred examples of the method is that if needed, the protective layer can be detached or removed from the workpiece without great effort while preserving the workplace and leaving no residue. In this case, a solvent is preferably used to remove the protective layer that dissolves components of the optionally multi-component carrier liquid remaining in the protective layer. This wet chemical removal of the protective layer can generally be carried out at ambient temperature and preserves the workpiece, as the protective layer does not need to be subjected to mechanical forces.

Alternatively to wet chemical solvents, however, a locally applied CO₂ beam (sometimes also referred to as a “snow jet”) can also be used to detach the protective layer. In this case, (liquid) CO₂ is decompressed on being discharged from a nozzle, accelerated to the speed of ultrasound by compressed air, and directed onto the sample. When this beam impinges on the protective layer, the layer cools rapidly and is embrittled as a result. As the CO₂ snow evaporates with a volume increase (600-fold) on impingement on the surface, particle coatings are generally blasted off the surface, leaving virtually no residue. This situation can be further promoted in that CO₂ is a strong solvent for organic compounds that may be present in a layer formulation as binders or stabilizers.

Although the protective layer generally adheres to the surface in positive-locking and planar fashion without gaps due to the application process (application of a coating fluid, partial or complete drying), the binding of the protective layer to the surface is generally not very strong. For this reason, it is possible in many cases to easily detach a protective layer that is strongly bonded per se as a whole. The protective layer can also be configured such that the individual particles (such as “flakes”) are prevented from direct contact with one another by non-volatile residues of the carrier liquid. Because of this, the binding between the particles need not be arbitrarily strong to achieve a reliable protective layer. Such a protective layer can be easily dissolved either by wet chemical means or another solvent application in that, for example, organic components between the particles are dissolved out.

As mentioned above, the protective layer may be present both in only partially dried (optionally wet) and in completely dried form. With respect to subsequent ease of detachability of the protective layer, method variations may be advantageous in which the laser machining is carried out during a drying phase of the applied layer within a time window in which the protective layer still contains an amount of carrier liquid. Such a layer that is not completely dried, but wet, can generally be removed from the workpiece surface relatively easily, e.g. by wet chemical methods, without leaving a residue.

It is possible to apply the coating over the entire workpiece surface and thus also cover with a protective layer the areas of the workpiece surface that are subsequently to be machined by a laser beam. For example, full-surface and structured application can be carried out by screen printing, doctoring, high-pressure atomization, spin coating, dip coating, pad printing or the like.

However, the method also offers the possibility, in application of the coating fluid, of applying the coating fluid to the surface in a locally limited manner only in a coating area comprising the machining area. For example, the coating area can be configured to be round, oval, or approximately polygonal or in the form of strips. It may lie distributed symmetrically or asymmetrically around the machining site. This local application means that outside of the coating area, the surface remains uncoated or free of the protective layer. With respect to the later expansion of the coating area, it is sufficient, to keep the surface clean, to reliably cover only the maximum flight radius of the ablation products (debris particles). These effects, which are important for edge rounding and with respect to heat management, are exerted laterally within a few micrometers around the respective machining site, while ablation particles, even under unfavorable circumstances, can also fly a distance of a few hundred micrometers or a few millimeters. With respect to these conditions, for example, coating areas can be so large that they cover a maximum range of 2 mm to 5 mm around the machining structure and, optionally, an even greater range. If the coating fluid or the protective layer is applied only in a locally limited manner, coating fluid can be saved, possible to a considerable extent, which is advantageous with respect both to the cost of the method and from the standpoints of speed and the environment.

If the protective layer is to be locally applied in a defined manner, volumetric methods appear above all to be suitable for the application of the coating fluid, for example, those using dosing valves (such as jet valves or piston- and spindle valves) or using spray valves. Optionally, by the continuous inkjet (drop-on-demand) method, individual drops of the coating fluid may be applied in a targeted manner to the target area (coating area) by electrostatic deflectors. Alternatively, spraying or gravure printing using a corresponding coating fluid formulation may be carried out in which the layer is optionally limited by a mask to a specified area (coating area).

In many cases, the coating fluid is applied directly to the surface of the workpiece so that the finished protective layer adheres directly to the workpiece. However, it is also possible, before application of the coating fluid, to apply an intermediate layer to the surface and then apply the coating fluid to the intermediate layer. In this manner, the protective layer becomes part of a multilayer, more particularly a dual-layer protective layer system. For example, the intermediate layer may serve as an adhesion-promoting layer. Alternatively or additionally, the material of the intermediate layer can also be selected such that to the extent possible, residue-free removal of the protective layer and the intermediate layer carrying the protective layer can be carried out after completion of the laser machining.

By the method, the quality of the laser micromachining can be controlled with respect to one or more objectives by using a multifunctional protective layer. The action of the protective layer can be at least threefold. First, by using a coating that can be removed without leaving any residue after machining, debris can be quite effectively prevented from adhering in the area of the machining site. Second, by applying a sufficiently thick protective layer, the edge rounding can be shifted into the protective layer, resulting in a workpiece with a very straight and “burr-free” flank. Third, the protective layer can be conducive to heat management in the immediate vicinity of the laser machining, for example, by improved heat dissipation. This makes it possible to effectively protect sensitive surfaces of the workpiece located close to the surface from damage due to the heat generation immediately adjacent to the edges that accompanies laser machining.

Further advantages are presented in the following description of preferred examples, which are explained below with reference to the figures.

In the following, examples of methods of producing a micromachined workpiece by laser ablation are presented. For example, the workpieces to be machined may be samples for microstructural diagnosis that can be prepared using the method with high quality. The method can also be used in the laser machining of displays or in machining of fine bores, e.g. in injection nozzles. In the method, a protective layer is directly or indirectly applied to a surface of the respective workpiece, and the surface is machined in a machining area by a laser beam irradiated through the protective layer.

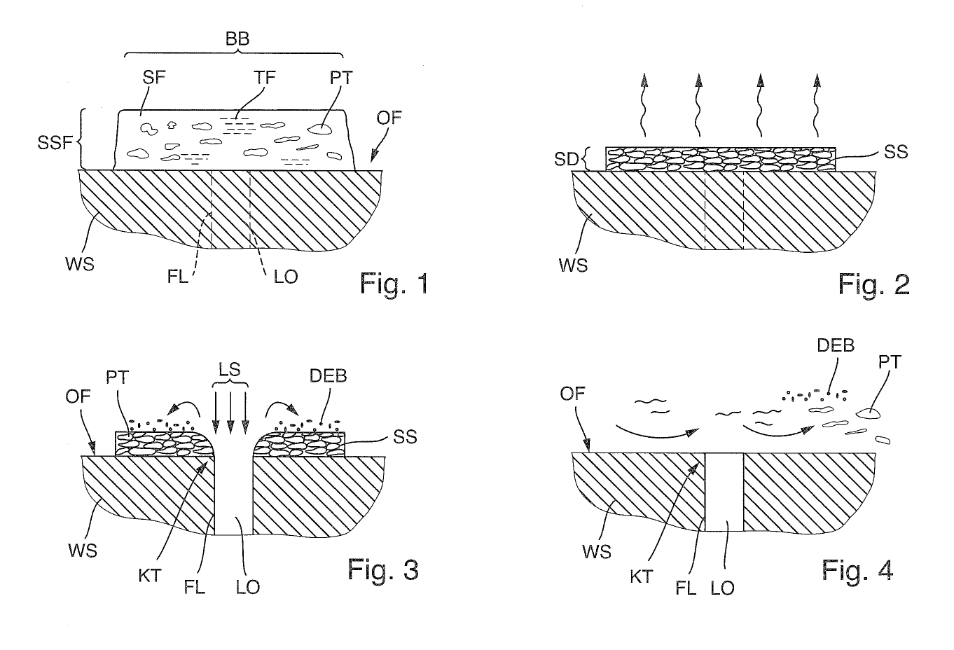

A few important partial aspects of examples are first explained with reference to FIGS. 1 through 4. FIG. 1 shows a schematic section through a workpiece WS in the vicinity of the surface OF of the workpiece in which a sharp-edged, limited hole LO with flanks FL running perpendicularly to the workpiece surface is to be produced by material ablating laser micromachining. The schematically shown hole which, for example, can have a round or polygonal cross section at least at its surface, is shown as a dotted line in the still intact workpiece. For purposes of clarity, the flanks in the figure are perpendicular to the surface, and most of them are at an inclined angle thereto. In the example, the surface OF of the workpiece (also referred to as the workpiece surface) is smooth in the machining area MA around the hole position, but it may also be more or less strongly structured.

In the method, the protective layer to be produced is formed using a coating fluid SF that contains an at least partially volatile carrier liquid TF in which metallic and/or ceramic particles PT are dispersed. In the example of FIG. 1, the coating fluid is applied directly to the surface OF of the workpiece such that at least the machining area BB around the desired position of the hole is covered with a protective coating fluid layer SSF. In the example, the coating fluid is applied in a locally limited manner such that only the machining area around the hole is covered, while portions of the workpiece located outside the area remain uncoated.

The step of applying the coating fluid is followed by a drying step that is schematically explained with reference to FIG. 2. During the drying step, the applied protective coating fluid layer SSF of coating fluid is dried to reduce the content of carrier liquid such that a protective layer SS forms from the coating fluid, which essentially consists only of a relatively dense composite of the particles PT of the applied coating fluid SF or of these particles and a sharply reduced content of the carrier liquid relative to the coating fluid.

On application, the particles may be contained in a multicomponent carrier liquid. During evaporation of the volatile components of the carrier liquid (optionally promoted by heating of the coated areas, e.g. by annealing in an oven, infrared irradiation, or the like), non-volatile components of the carrier liquid remain as residue between the particles. On the one hand, the non-volatile components can maintain the contact between the particles or promote the cohesion of the partially porous protective layer, and on the other, they also ensure re-detachability by methods that act on the remaining components of the carrier liquid, e.g. to chemically dissolve them.

On evaporation of volatile components of the carrier liquid, the particles gradually come into close contact with one another and form a protective layer SS that adheres relatively firmly to the surface OF, with the effective layer thickness SD being significantly less than the thickness of the previously applied coating fluid. During the drying phase, the degree of moisture of the coating constantly decreases, optionally until complete drying of the protective layer SS. However, highly volatile or non-volatile components of the carrier liquid may also remain in the protective layer. In any event, the drying should have progressed to a sufficient extent before the beginning of laser machining so that the more or less dry protective layer remains adhering to the workpiece surface, even when the surface is tilted out of the horizontal plane.

FIG. 3 is a schematic view of the machining step, in which the machining area is machined by a laser beam LS irradiated through the protective layer SS onto the workpiece and successively penetrates deeper into the workpiece to produce the hole LO. Some of the problems occurring in micromachining can be explained in a clear manner using FIG. 3.

A substantial problem is so-called edge damage or edge rounding, which derives essentially from the Gaussian intensity distribution of the laser beam LS. This intensity distribution results in non-uniform ablation characteristics over the cross section of the beam and occurs practically inevitably during “running in” of the laser beam on the target site. This causes the hole to be enlarged in the vicinity of the surface, which is generally undesirable. In many cases of practical applications, above all in the field of IC technology, i.e. in the field of laser machining of integrated semiconductor components, the target sites to be prepared were located in the vicinity of the workpiece surface, for which reason rounding of the edge in laser machining was frequently prevented by maintaining greater safety distances relative to the target site. However, this can result in longer machining times for final polishing by a focussed ion beam (FIB), which can significantly reduce the efficiency of a combined laser-FIB process.

As can be clearly seen in FIG. 3, the problem of rounding of the laser-machined edge is generally not solved by application of the protective layer. However, the rounding is shifted in a vertical direction into the protective layer SS so that edge rounding forms on the entry side of the hole produced by the laser beam inside the protective layer SS. In the particularly critical edge area KT in the transition area between the surface OF of the workpiece and the flank FL of the hole, however, a sharp, largely intact transition forms between the workpiece surface and the ablated edge or flank.

It is apparent that the effective layer thickness of the protective layer SS should be selected such that the area of the edge rounding lies exclusively inside the protective layer so that the workpiece edge remains clean. The thickness of the protective layer to be applied is in a specified ratio to the irradiation profile, especially to the spot diameter. The layer thickness of the protective layer to be achieved can essentially be determined by taking into account the powder density and the spot profile (M² value) of the laser source used. Where applicable, this is technically limited by the type of application or the size of the metal particles located in the layer system. The required effective layer thickness of the protective layer is substantially affected by the ratio of the fluence-dependent, wavelength-dependent, and pulse-dependent ablation thresholds of the substrate and the protective layer. This can be taken into consideration in designing the process for production of the protective layer.

A second problem is adhesion of the ablation products (debris) of the laser machining to a laser-machined surface. The adhesion of debris DEB can be seen as the result of insufficient removal of ablated workpiece material during the laser machining. Although in many laser facilities, discharging of debris is promoted on the machine side by dedicated blowing-in and suctioning-out systems, contamination of the direct surface of the workpiece cannot be completely prevented in practical terms, as the attachment is due less to adhesion than to “baking on” of the ablated particles. This is also the case in machining by somewhat longer ultrashort pulse lasers (with a pulse duration of more than a few picoseconds), as the ablated particles are further irradiated by the laser during their removal, resulting in a post-heating effect. As can be seen in FIG. 3, the re-deposition of ablation products or debris DEB on the surface OF is prevented by the presence of the protective layer SS, as the ablation products in the machining area protected by the protective layer cannot be deposited on the workpiece surface OF, but can only be deposited on the protective layer SS and bind thereto. The ablation products can then be removed together with the protective layer SS, preferably without leaving any residue (cf. FIG. 4).

If a material such as sapphire that conducts heat poorly is machined, this can cause heat accumulation during laser machining and uncontrollable, sometimes extensive damage in the vicinity of the laser-machined edges. In the case of a protective layer SS with high thermal conductivity, for example, a metallic protective layer, discharging of heat in a lateral direction (i.e. essentially parallel to the surface) is promoted so that problems resulting from heat accumulation can be reduced.

Although it is possible in some cases that the protective layer together with the ablation particles deposited thereon will remain on the workpiece, as a rule, residue-free detachment of the protective layer is ideally preferred. FIG. 4 schematically shows a variant of the method step of removing the protective layer and the debris DEB deposited thereon by a wet chemical solvent that partially dissolves soluble residual components of the carrier liquid in the protective layer so that the cohesion of the particles PT in the protective layer breaks down and the particles PT and the debris DEB can be flushed from the surface OF without leaving any residue. As needed, this cleaning process can be supported by the action of ultrasound. Alternatively, detachment of the protective layer can also be carried out, for example, by CO₂ snow jet cleaning (cf. FIG. 10).

A particularly promising solution for the above problems is considered to be the application of printable lacquer systems that can be removed without leaving any residue using nanocolloidal metal particles or micrometer-sized metallic or ceramic flakes. Because of their favourable electrical and thermal conductivity, for example, commercially available metal inks or metal lacquers with particles of silver, gold, aluminium, copper or nickel or combinations thereof can be considered, optionally combined with correspondingly small ceramic particles.

In an example explained in greater detail below, a commercial silver-containing conductive lacquer (“conductive silver”) from Ted Pella Inc. was used. Measurements showed that approximately 80% of the flaky particles composed essentially of silver had a size of less than 1 μm. This coating fluid contains an alcohol-based volatile carrier liquid. Other commercially available conductive lacquers that are suitable as conductive fluids are ketone based (such as methylisobutylketone) or acetate based.

For laboratory-scale applications, for example, the coating fluid may be applied to the working area in question using a brush. For larger piece quantities and/or mass production such fluids can also be applied in a printing process to the workpiece surface in a locally limited manner by volumetric methods. The tested silver-based conductive lacquers can be removed from the workpiece surface without leaving a residue by immersion in acetone or alcohol, optionally supported by ultrasound.

An advantage of the use of silver-containing conductive lacquers is that silver can be manufactured without problems on an industrial scale in usable particle sizes (typically smaller than 10 μm) and that silver shows favorable thermal conductivity per se. However, it is also possible to process other metals (such as aluminium or brass) in ball mills into corresponding flakes. Metal flakes, i.e. flake-like metal particles of small size, are also widely used as substrates for special-effect pigments used in lacquers to provide sparkling and coloring effects. To provide coloring, such flakes are coated with nanoscale interference layers. Coating fluids containing such particles can also be used.

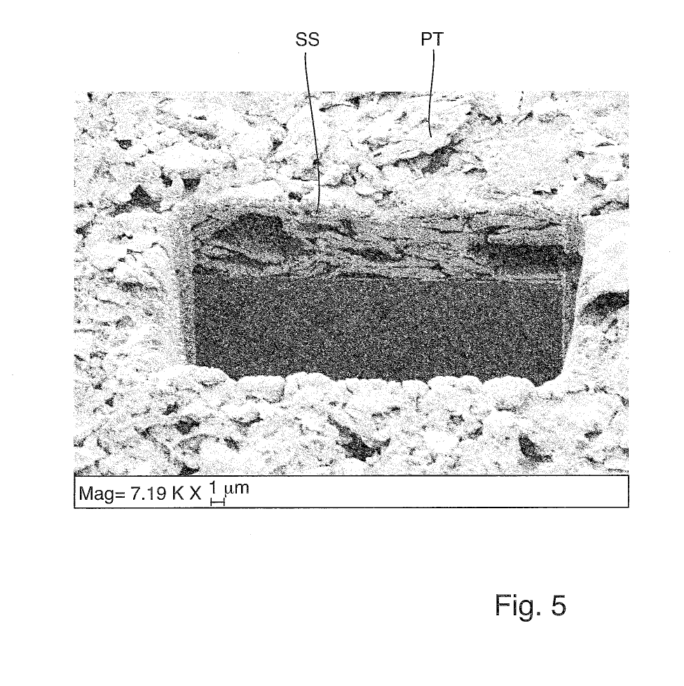

In a series of experiments, conductive silver was applied to a machining area to be machined using a brush in a thickness such that the resulting protective layer SS, after evaporation of the volatile components of the carrier liquid, had an effective protective layer thickness SD of approx. 4 to 20 μm. FIG. 5 shows a scanning electron microscope image of a workpiece covered with a protective layer of conductive silver after drying of the conductive silver layer. To more clearly show the inner structure of the protective area and the transition area to the workpiece, a rectangular excavation was produced using a focussed gallium ion beam (ablation of a large material volume relative to the ion beam).

It can be seen that the protective layer SS consists essentially of small, predominantly plate-shaped or flake-shaped particles PT in direct contact with one another inside the coating so that the coating as a whole consistently shows electrical and favourable thermal conductivity. Because of the flake structure of the particles, the protective layer has a scalelike surface. Microscopically small or even nanoscale pores can be seen between the particles that are in physical contact with one another. The pores have formed during evaporation of the volatile components of the carrier liquid during the drying step. The filling ratio of the particles within the protective layer, i.e. the ratio of the total volume of the particles in a unit volume of the protective layer to the observed unit volume, is typically approx. 60% to 80% so that the pore percentage is about 20 to 40%.

This thin, predominantly metallic protective layer is characterized by a relatively high ablation threshold in laser machining, wherein this ablation threshold can be similar to that of the underlying solid material (semiconductor material) of the workpiece. In this manner, the microporous protective layer, with respect to the material ablation in laser machining, behaves similarly to the underlying solid workpiece material, and more particularly (in contrast to purely organic coatings of the same thickness), is not ablated at a much faster rate.

In the area of the transition between the protective layer and the underlying workpiece material, in contrast, the flank exposed by laser machining runs more or less perpendicularly to the workpiece surface. This leaves a sharp-edged transition in the transition area between the flanks and the surface after detachment of the protective layer.

Because of the presence of the protective layer, the ablation products generated in laser machining cannot be deposited on the surface of the workpiece during the laser machining, but at the most on the rough surface of the protective layer. They are then removed together with the layer.

With respect to the problem of deposition of debris on the workpiece surface, the protective layer should cover at least the area around the machined site that can be reached by the ablation products during laser machining. The average free path length or the average flight distance of the particles depends to a considerable degree on the ambient pressure. In machining under a vacuum, particulates may even fly several tens of centimeters. For practical reasons, however, laser micromachining under vacuum conditions is usually avoided. However, observations on average flight distance can be utilized in designing the proper size of the area to be covered by the protective layer.

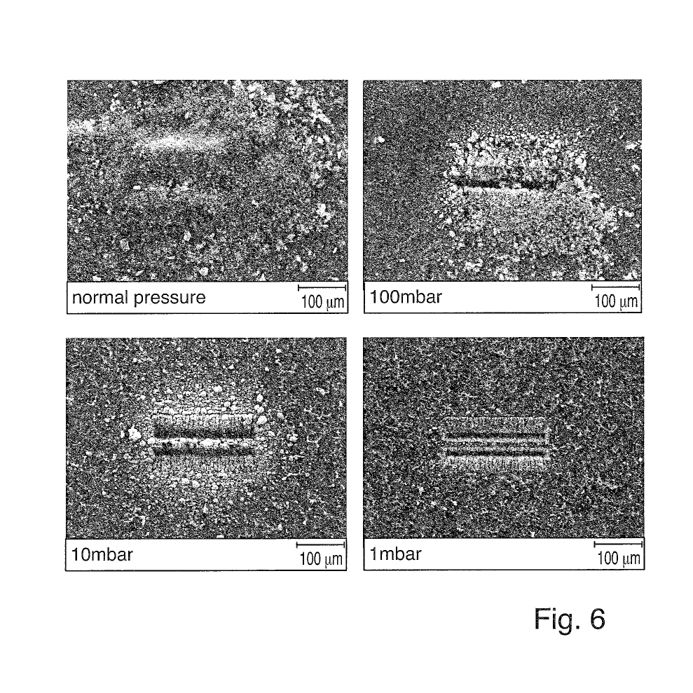

As an example of how the average flight distance, under otherwise identical conditions, depends among other factors on ambient pressure, FIG. 6 shows four scanning electron micrographs of the area around a machining structure after laser machining under different ambient pressure conditions. The status after machining at standard pressure (approx. 1000 mbar) is shown at upper left. There is a high density of deposited particles in a relatively small area around the machined structure. A comparable situation after machining at 100 mbar is shown at upper right. In this case, a strong effect on the average flight distance cannot be seen. As is the case at standard pressure, the particles are predominantly dispersed in an area of less than 1 mm around the machining site. The status after machining at 10 mbar ambient pressure is shown at lower left. There is a relatively uniform distribution over a relatively large surrounding area around the machining site, and the density of the particles appears to be somewhat greater only in the immediate vicinity of the machining site. In machining at strong negative pressure of 1 mbar (lower right), one can see a more even distribution of the ablation products over an even larger area or an even larger radius.

It can be estimated from such experiments how the spatial distribution of ablation products around the machining site can be influenced by adjusting the ambient pressure. For example, one can also optionally operate at excess pressure to reduce the flight distance. For example, the machining process can be carried out such that an ambient pressure is set that predominantly allows the debris particles to land a maximum of 2 to 5 mm from the machining site. In local coating around the machining site, the size of the coated area can be selected to be correspondingly large. Areas that are clearly beyond the average flight distance can remain uncoated.

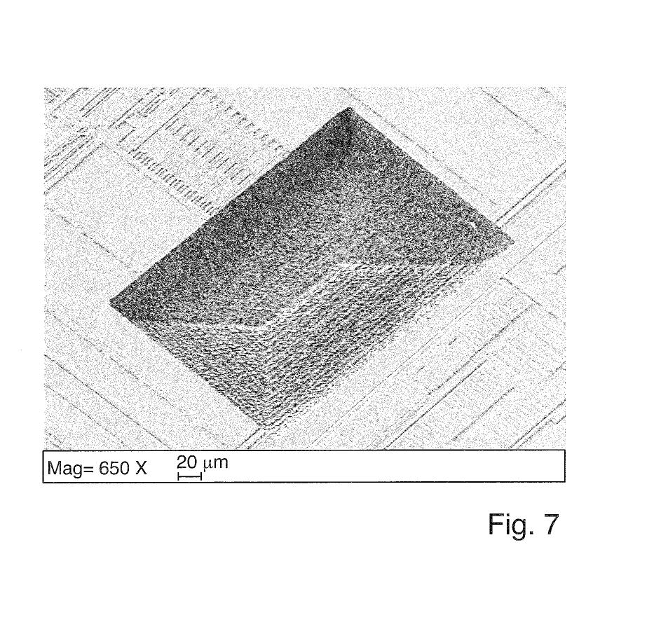

A great advantage of our methods is that by using the protective layer-forming coating fluid, it is possible to reliably protect not only flat surfaces, but also uneven workpiece surfaces, i.e. workpiece surfaces with a structured surface such as those occurring, for example, in functional semiconductor components. The protective layer can also adapt in a positive-locking and topography-adapted manner to such structures. To illustrate this, FIG. 7 shows an SEM image of a semiconductor sample that was laser-machined and structured using a conductive silver protective layer after removal of the protective layer and the ablation products removed along with the layer. It can be seen that the surface OF of the workpiece again exposed after removal of the protective layer shows structures in the form of beads or lines parallel to one another.

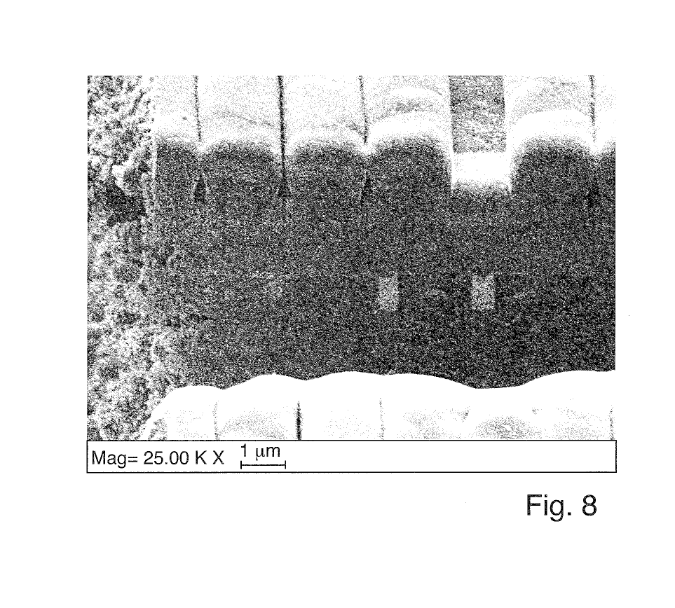

It can be seen from the expanded detail view in FIG. 8 that no more machining residues remain on the structured workpiece surface and that any zone of the workpiece that may have been affected by laser irradiation is of only minor size.

It can be seen that the protective layer containing the metal flakes can be removed without leaving any residue after application and laser micromachining. It can also be seen that the metal particle layer can assume an important role in heat management of the machined site because of the favorable contact and its high thermal conductivity. For example, it may be that in machining with a picosecond laser, the thermal effect zone, even in a relatively thick heterosystem, typically measures no more than 2 μm. It can also be seen that after detachment of the metal particle layer (protective layer), no debris can be seen on the surface adjacent to the machining flank. Neither can any burr be seen on the cut edge.

There may be situations in which it is difficult to sufficiently satisfy multiple requirements for control at the same time and to the same degree, for example, with respect to preventing edge rounding, preventing deposits on the free workpiece surface, and heat management. If applicable, a compromise must be sought between the densest possible packing of the metal particles in the protective layer (for reasons such as maximum thermal conductivity) on the one hand and the greatest possible porosity of the coating for favorable solubility of non-metallic components such as binders and stabilizers on the other. In view of these contradictory requirements, it may be advantageous to proceed according to a variant of the method in which the coating fluid is not directly applied to the workpiece surface to be protected, but is applied with an interposed intermediate layer, which is applied to the workpiece surface before applying the coating fluid to the free surface of the intermediate layer.

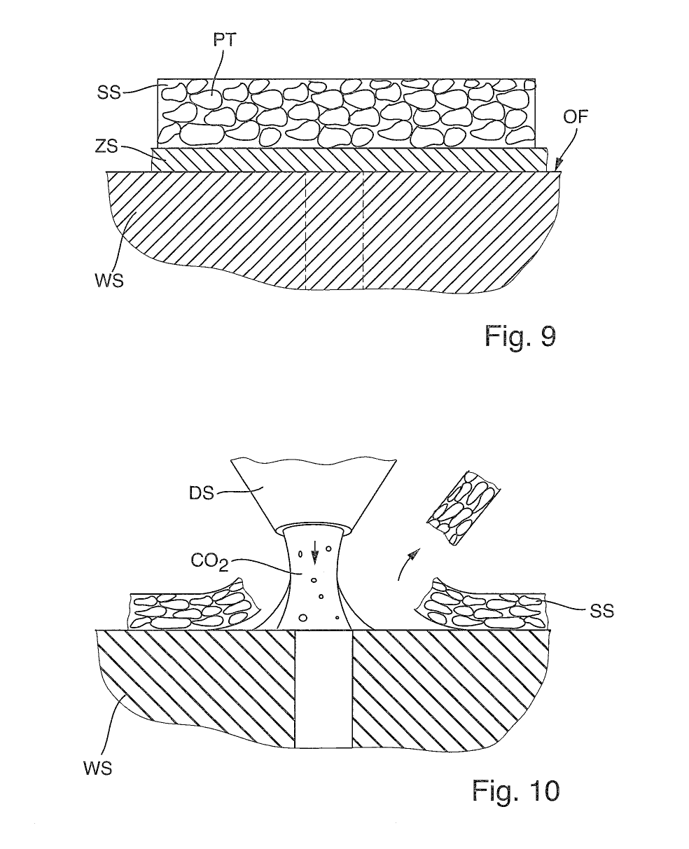

In this connection, FIG. 9 shows a schematic section through a workpiece surface to which an optionally particle-free intermediate layer ZS was first applied, after which the actual particle-containing protective layer SS was applied to this intermediate layer. For example, the material for the intermediate layer ZS can be selected such that wet chemical or CO₂ beam-based detachment of the entire protective layer system (protective layer SS plus intermediate layer ZS) can be carried out easily. In contrast to direct application of the protective layer to the surface of the workpiece, in this case, the particle-containing protective layer SS is deposited on a film which itself is detachable, namely the intermediate layer. This obviates the need for detachability of the actual particle layer (protective layer), which is optionally removed in a planar manner (as a coherent whole) together with the debris deposited thereon when the intermediate layer is detached. Here, the intermediate layer is protected from direct laser exposure by the particle-containing protective layer SS. Among other reasons, it is therefore not necessary for the intermediate layer ZS to contain metal particles and/or ceramic particles (e.g. composed of TiO₂). However, this can be provided.

For variants with individual layers, i.e. a protective layer that is applied directly to the surface of the workpiece, specified requirements include the following: the protective layer should have a sufficiently high ablation threshold in laser machining and should be applicable with a sufficient thickness. The layer should preferably show favorable detachability from the surface and high thermal conductivity. Due to its structure, the protective layer may if applicable compensate for thermomechanical stresses within certain limits.

In examples that have an intermediate layer between the protective layer and the workpiece surface, care should be taken to ensure that there is no incineration of the intermediate layer material due to laser coupling and that the intermediate layer material is applicable with sufficient thickness. The intermediate layer can be particle-free or optionally mixed with ceramic particles to promote thermal decoupling of the workpiece surface from a metal particle-containing protective layer. The intermediate layer can also function as a thermomechanical adaptation layer to compensate for induced thermomechanical stresses between the workpiece and the protective layer.

There are various possibilities of applying the protective layer or a protective layer system with a combination of a protective layer and an intermediate layer to the workpiece. This technology, by which the protective layer/the protective layer system can be reproducibly applied, depends not only on the formulation of the coating fluid, but on the specific application in question.

In the application in the area of isolation technology (such as IC isolation and display packaging), it appears most advantageous to apply the protective layer in an unstructured manner to the entire surface of the structure to be isolated (such as a semiconductor wafer). Suitable methods for this purpose include screen printing, doctoring, high-pressure atomization, spin coating, dip coating, pad printing or the like.

If the protective layer is to be applied in a defined locally limited manner so that uncoated areas will also remain, the most suitable methods here appear primarily to be volumetric methods using dosing valves (such as jet valves, piston valves, and spindle valves) or spray valves. By the continuous inkjet (drop-on-demand) method, individual drops can also be applied in a targeted manner to the target site using electrostatic deflectors. Alternatively, spraying or gravure printing of a corresponding coating fluid formulation can be carried out in which coating is optionally limited to a specified area using a mask. For example, locally limited application of coating fluid can be advantageous in the context of process testing or in in the preparation of samples for microstructural diagnosis.

In most specific applications, the protective layer should be removed from the workpiece without leaving any residue after the laser machining. More particularly, two methods appear suitable for this purpose. If binders and stabilizers of components of the carrier liquid having a certain chemical solubility are present in a particle-based protective layer, the protective layer can be removed over a large surface by flushing with a suitable solvent (cf. FIG. 4). In some cases, this process can be supported mechanically (such as by brushing) or by ultrasound.

Alternatively, the protective layer or protective layer system may be locally removed from the surface using a CO₂ snow jet (cf. FIG. 10). In this case, (liquid) CO₂ is decompressed on being discharged from a nozzle DS, accelerated to the speed of ultrasound by compressed air, and directed onto the workpiece WS provided with the protective layer SS. When it impinges on the protective layer, the layer cools rapidly and is embrittled. As the CO₂ snow evaporates with a volume increase on impingement on the surface, particle coatings are generally blasted off the surface of the workpiece leaving virtually no residue. This situation is further promoted in that CO₂ is a strong solvent for organic compounds that may be present in a layer formulation as binders or stabilizers. Successful experiments were conducted with a system for CO₂ snow beam cleaning of the firm acp—advanced clean production GmbH, Ditzingen, Germany.

Technically, a device for applying the layer (i.e. a coating system for producing a protective layer on the workpiece), for example, with continuous inkjet or dosing valves, can be implemented in a laser micromachining unit with a tool moving system. In addition to a laser machining position, such units may also have an observation position, wherein it is preferably possible, with knowledge of the offset, to switch back and forth between the positions with a high degree of precision, for example, with repetition precision of less than 1 to 2 μm. In addition, another coating position, more particularly in the form of a printing position, may be provided in which application of the coating fluid to produce the protective layer can be carried out with the same precision. Thicker layers can be produced as needed by multiple printing and/or the selection of larger droplets.

For the borderline case of large-surface coatings, it can be advantageous to first coat the workpieces (such as wafers) in a separate special system and then transfer them in lots or continuously to the laser machining system. Removal of the protective layer is also preferably carried out in a separate system or a separate process step.

Our methods allow a significant increase in quality in laser-based production of precision components such as bores in injection nozzles or displays or production of samples for microstructural diagnosis. Running-in behavior, entry geometry, contamination with ablation products, and thermal stress on the machined workpieces can be improved.

What is claimed is:

1. A method of producing a micromachined workpiece by laser micromachining, comprising applying a protective layer (SS) to a surface (OF) of the workpiece (WS) and machining the surface in a machining area by a laser beam (LS) through the protective layer,
wherein
the protective layer (SS) is produced using a coating fluid (SF) containing an at least partially volatile carrier liquid (TF) in which metallic and/or ceramic particles (PT) are dispersed;
the coating fluid (SF) is applied to the surface (OF) such that at least the machining area (MA) is covered with a protective coating fluid layer (SSF);
the applied coating is dried to reduce the content of carrier liquid (TF) such that a protective layer (SS) forms, which is essentially composed of the particles (PT) of the applied coating fluid or of these particles and a reduced content of the carrier liquid relative to the coating fluid; and
machining of the machining areas is carried out by a laser beam (LS) irradiated through the protective layer onto the workpiece (WS).

2. The method according to claim 1, wherein a coating fluid is used in which the particles predominantly have a maximum particle size of 10 μm.

3. The method according to claim 1, wherein the composition of the coating fluid (SF) is selected such that a filling ratio of the particles (PT) in the finished protective layer (SS) is over 50% of the protective layer volume, and the filling ratio is more than 60%.

4. The method according to claim 1, wherein a coating fluid (SF) is used that predominantly or exclusively contains metallic particles (PT) with or without a coating.

5. The method according to claim 1, wherein a conductive lacquer is used as a coating fluid (SF).

6. The method according to claim 1, wherein the protective layer is produced with an effective protective layer thickness (SD) of less than 50 μm.

7. The method according to claim 1, wherein the protective layer (SS) is removed from the surface (OF) after completion of the laser machining.

8. The method according to claim 7, wherein, to remove the protective layer (SS), a solvent is used that dissolves non-volatile or sparingly-volatile components of the carrier liquid remaining in the protective layer, or to remove the protective layer (SS), a CO₂ beam directed onto the protective layer is used.

9. The method according to claim 1, wherein the laser machining is carried out during a drying phase of the coating within a time window in which the protective layer (SS) still contains an amount of carrier liquid.

10. The method according to claim 1, wherein in applying the coating fluid (SF), the coating fluid is applied in a locally limited manner to a coating area on the surface (OF) containing the machining area (MA), wherein the surface (OF) remains uncoated outside of the coating area.

11. The method according to claim 10, wherein by adjusting ambient pressure, a spatial distribution of ablation products around the machining site is affected, and the ambient pressure is set to cause the ablation products to land predominantly at a maximum distance of 2 to 5 mm from the machining site.

12. The method according to claim 1, wherein in applying the coating fluid, the coating fluid is applied by a volumetric method.

13. The method according to claim 1, wherein before application of the coating fluid (SF), an intermediate layer (ZS) is applied to the surface (OF) and the coating fluid is applied to the intermediate layer.
